(19) United States
(12) Patent Application Publication
(10) Pub. No.: US 2011/0025023 A1
(43) Pub. Date: Feb. 3, 2011

(54) INFLATOR-AIRBAG INTERFACE

(76) Inventors: Mark S. Hatfield, Providence, UT (US); Kevin Button, Plain City, UT (US)

Correspondence Address: Sally J. Brown;AUTOLIV ASP, INC., 3350 Airport Road, Ogden, UT, 84405, US

(21) Appl. No.: 12/511,810

(22) Filed: Jul. 29, 2009

(51) Int. Cl. B60R 21/20; F16J 15/00

(52) U.S. Cl. 280/728.2; 277/316

(57) ABSTRACT

An airbag deployed by pressurized gas emitted from an inflator in a vehicle passenger safety module includes an inflation portion that captures pressurized gas from the inflator and an inlet portion that communicates with the inflation portion and is configured to receive and to be secured to the outer surface of the discharge end of the inflator. A substantially continuous elastomeric gasket made of cured liquid silicone is carried on the interior surface of the inlet portion at a location that circumscribes the outer surface of the discharge end of the inflator, when the discharge end is received into the inlet portion. The transverse extent of the gasket is substantially smaller than its longitudinal extent, while the thickness of the gasket is greater than the thickness of the wall of the inlet portion of the airbag upon which the gasket is carried. Thus, a coupling structure for effecting the interconnection between an inflator and an airbag in a vehicle passenger safety module takes the from of a cured band of liquid sealant that is disposed between an exterior surface of the discharge end of the inflator and an interior surface of an inlet portion of the airbag due to being is secured directly to the interior surface of the inlet portion.

### BACKGROUND OF THE INVENTION

1. Field of the Invention

The present invention relates to vehicle passenger safety modules that use pressurized gas from an inflator to deploy an airbag cushion between passengers and the interior of a vehicle in the event of a collision. More particularly, the present invention relates to the interface between the inflator and the airbag in such vehicle passenger safety modules.

2. Background

A typical airbag for a vehicle passenger safety module includes an inflation portion that captures pressurized gas from an inflator, thereby becoming a gas-filled cushion that can be interposed between a vehicle occupant and the interior vehicle surfaces surrounding that occupant. The inflator is ignited electrically in response to a momentum monitor carried in the vehicle.

One end of the inflator produces pressurized gas, while the other, the discharge end of the inflator, emits the pressurized gas into the airbag. If the airbag is complex or extensive, as for example is the case with curtain airbags that inflate at the sides of the passenger compartment, the discharge end of an associated inflator may incorporate a gas guide for directing the pressurized gas in directions and in quantities that are optimally suited to efficiently inflating the airbag.

To effect an attachment between an inflator and an associated airbag, the airbag includes a sleeve-like inlet portion that communicates pneumatically at one end thereof with the inflation portion of the airbag. The opposite end of the inlet portion of the airbag opens to the outside of the airbag. When the elements of a vehicle passenger safety module are assembled in a vehicle, the open end of the inlet portion is advanced over and secured to the exterior of the discharge end of the inflator. The attachment between the inlet portion of an airbag and the discharge end of an inflator is desirably both mechanically secure and pneumatically sealed.

### BRIEF SUMMARY OF THE INVENTION

According to teachings of the present invention, an airbag in a vehicle passenger safety module deployed by pressurized gas emitted from the discharge end of an inflator of the safety module includes an inflation portion in which to capture pressurized gas from the inflator, an inlet portion pneumatically communicating with the inflation portion and configured to receive and to be secured to an outer surface of the discharge end of the inflator, and an elastomeric gasket carried on an interior surface of the inlet portion at a location opposing the outer surface of the discharge end of the inflator, when the discharge end of the inflator is received into the inlet portion. The gasket, which is made of cured liquid silicone adhesive, is substantially continuous, thereby to circumscribe the discharge end of the inflator under such circumstances. The transverse extent of the gasket is substantially smaller than the longitudinal extent thereof, while the thickness of the gasket is greater than the thickness of the wall of the inlet portion of the airbag upon which the gasket is carried.

In one aspect of the present invention, a coupling structure for effecting the interconnection between an inflator and an airbag in a vehicle passenger safety module takes the from of a cured band of liquid sealant that is disposed between an exterior surface of a discharge end of the inflator and an interior surface of an inlet portion of the airbag. The cured band is carried on the interior surface of the inlet portion of the airbag, secured directly thereto, thereby to circumscribe the discharge end of the inflator.

The cured band, which may be made of cured liquid silicone adhesive, is substantially continuous in longitudinal extent, has a transverse extent that is substantially smaller than the longitudinal extent thereof, and exhibits a thickness that is greater than the thickness of the wall of the inlet portion of the airbag.

Yet another aspect of the present invention provides a method for manufacturing a vehicle passenger safety module airbag of the type that includes an inlet portion configured to receive the discharge end of the inflator of the safety module. A substantially continuous band of curable liquid sealant is formed against an interior surface of the inlet portion of the airbag at a location opposing and circumscribing the outer surface of the discharge end of the inflator, when the discharge end of the inflator is received into the inlet portion of the airbag. The band of liquid sealant is cured to produce an elastomeric gasket carried on the interior surface of the inlet portion of the airbag. The gasket engages the outer surface of the discharge end of the inflator, when the discharge end of the inflator is received into the inlet portion of the airbag. The curable liquid sealant may be a liquid silicone adhesive.

Where the inlet portion of the airbag is made up of first and second circumferentially-defined neck segments of respective first and second flexible constituent airbag panels, the continuous band of curable liquid sealant is formed by initially applying a first bead of curable liquid sealant to an interior surface of the first neck segment in substantial alignment with a circumferential direction about the inlet portion of the airbag. Then an elongated mandrel having substantially parallel edges is disposed against the first bead of the sealant in longitudinal alignment with the neck segment. This produces from the first bead of sealant a first band of the sealant. A second bead of the sealant is applied to the side of the mandrel opposite from the first bead of sealant in substantial alignment therewith. An interior surface of the second neck segment is then urged against the second bead of the sealant with the second neck segment in longitudinal alignment with the first neck segment. This in turn produces a second band of the sealant from the second bead of sealant. The first neck segment is secured to the second neck segment along respective of the edges of the mandrel, forming the inlet portion of the airbag.

The first band of the sealant and the second band of the sealant together form a substantially continuous band of the sealant, and the step of curing is conducted with the mandrel between the first neck segment and the second neck segment contacting and circumscribed by that substantially continuous band of the sealant. Curing produces from the substantially continuous band of liquid sealant an elastomeric gasket that adheres to the first neck segment and to the second neck segment, but that is nondestructively disengageable from the mandrel. Consequently, the mandrel can be extracted from the center of the gasket and withdrawn from the inlet portion of the airbag.

The mandrel has a width measured transverse the longitudinal extent thereof that is substantially greater than the thickness thereof. The perimeter of a transverse cross section of the mandrel is generally greater than or approximately equal to the perimeter of a transverse cross section of the discharge end of the inflator that is intended to be assembled with the airbag produced in the manner described.

### BRIEF DESCRIPTION OF THE SEVERAL VIEWS OF THE DRAWINGS

In order that the manner in which the above-recited and other features and advantages of the present invention are obtained will be readily understood, a more particular description of the present invention briefly described above will be rendered by reference to specific embodiments thereof that are illustrated in the appended drawings. Understanding that these drawings depict only typical embodiments of the present invention and are not therefore to be considered to be limiting of the scope thereof, the present invention will be described and explained with additional specificity and detail through the use of the accompanying drawings in which:

FIG. 1 is an elevation view, superimposed against a profile in phantom of the side windows of a typical passenger vehicle, of an inflated curtain airbag for a vehicle passenger safety module attached to an inflator by a first embodiment of a coupling structure embodying teachings of the present invention;

FIG. 2 is a perspective view of the coupling structure of FIG. 1;

FIG. 3 is a cross-sectional elevation view of the coupling structure of FIG. 2 taken along section line 3-3 therein;

FIG. 4 is a perspective view of a second embodiment of a coupling structure embodying teachings of the present invention;

FIG. 5 is a cross-sectional elevation view of the coupling structure FIG. 4 taken along section line 5-5 therein;

FIG. 6 is a disassembled plan view of a pair of constituent airbag panels showing in dashed lines at the edges of each the location at which the panels are secured to from the airbag of FIG. 1;

FIGS. 7A-7F are diagrams depicting steps in a method for manufacturing an airbag according to teachings of the present invention that carries an elastomeric gasket with which to effect a mechanically secure and pneumatically sealed attachment of the airbag to the exterior surface of the discharge end of an associated inflator; and

FIG. 8 is a flow chart presenting typical steps in method for manufacturing an airbag according to teachings of the present invention depicted in FIGS. 7A-7F.

### DETAILED DESCRIPTION OF THE INVENTION

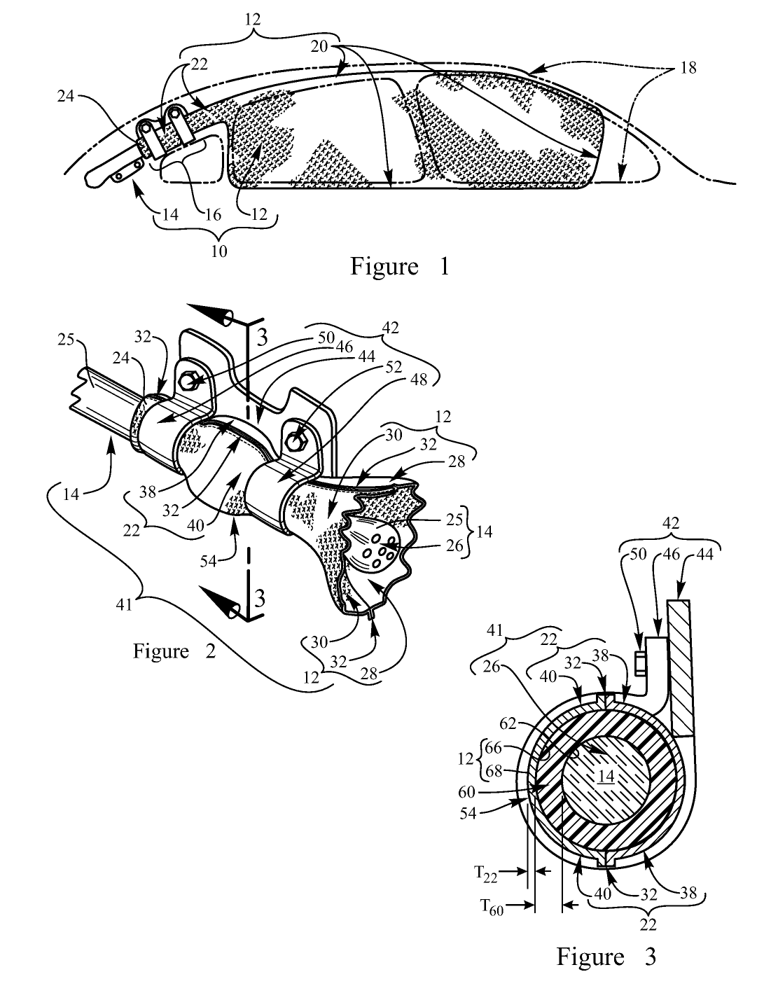

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of embodiments of the present invention, as represented in FIG. 1-8, is not intended to limit the scope of the invention, as claimed, but is merely representative of presently preferred embodiments of the invention.

FIG. 1 is an elevation view of a vehicle passenger safety module 10 that includes an inflated curtain airbag 12 attached to an inflator 14 by a first embodiment of a coupling structure 16 embodying teachings of the present invention. These elements of safety module 10 are for perspective superimposed against a profile in phantom of a side of a typical passenger vehicle 18. Airbag 12 includes an inflation portion 20 that captures pressurized gas from inflator 14 and a sleeve-like inlet portion 22 that communicates at one end thereof with inflation portion 20. The opposite, open end 24 of inlet portion 22 communicates with the outside of airbag 12. Open end 24 of inlet portion 22 has been advanced over and secured to the exterior of an end of inflator 14 that is not visible in FIG. 1, but from which pressurized gas was emitted to fill inflation portion 20 of airbag 12.

FIG. 2 is a perspective view of the portion of FIG. 1. Apparent thusly, are additional details of coupling structure 16, inflator 14, and open end 24 of inlet portion 22 of airbag 12. For example, inflator 14 has an exterior surface 25, and airbag 12 has been broken away to reveal a discharge end 26 of inflator 14 that is completely enclosed within airbag 12. Also, airbag 12 can be seen to include a pair of flexible constituent panels, a first airbag panel 28 and a second airbag panel 30, which are secured together at the edges thereof, forming a peripheral seam 32 of airbag 12. In this light, inlet portion 22 of airbag 12 is made up of a pair of circumferentially-defined neck segments of first airbag panel 26 and of second airbag panel 28, respectively. These are a first neck segment 38 of first airbag panel 28 and second neck segment 40 of second airbag panel 30. In FIG. 2, inlet portion 22 of airbag 12 is disposed on exterior surface 25 of discharge end 26 of inflator 14, producing what will for convenience hereinafter be referred to as an interface subassembly 41.

Coupling structure 16 includes an attachment bracket 42 having a planar base plate 44, a curved first retention strap 46, and spaced apart therefrom a curved second retention strap 48. First retention strap 46 and second retention strap 48 are integrally-formed with base plate 44, projecting from a lower edge thereof that is obscured in FIG. 2 by interface subassembly 41. Base plate 44 is secured to a structural element of a vehicle, such as vehicle 18 shown in phantom in FIG. 1, by means not relevant to the present invention. First retention strap 46 and second retention strap 48 wrap circumferentially about interface subassembly 41 at spaced-apart locations along the length thereof. The free end of first retention strap 46 is fastened by a first bolt 50 to or through base plate 44 as shown, while the free end of second retention strap 48 is similarly secured using a second bolt 52. First retention strap 46 and second retention strap 48 together preclude lateral displacement of interface subassembly 41. If first retention strap 46 and second retention strap 48 exert a sufficiently strong radially-inwardly directed grip on interface subassembly 41, first retention strap 46 and second retention strap 48 will also fix the longitudinal position of interface subassembly 41 and maintain the integrity of interface subassembly 41 during the activation of airbag 12.

Toward those ends, an inflator-airbag interface, such as coupling structure 16, is provided according to teachings of the present invention with an elastomeric gasket that is carried on an interior surface of inlet portion 22 of airbag 12 at a location that opposes exterior surface 25 of discharge end 26 of inflator 14, when discharge end 26 of the inflator 14 is received into inlet portion 22 of airbag 12. In interface subassembly 41, such a gasket thus becomes sandwiched between exterior surface 25 of inflator 14 and an interior surface of inlet portion 22 of airbag 12. While not directly visible in FIG. 2, it is a gasket embodying such teachings of the present invention that causes a circumferential bulge 54 to appear on the exterior of inlet portion 22 of airbag 12 between first retention strap 46 and second retention strap 48.

FIG. 3 is a cross-sectional elevation view of coupling structure 16 taken at bulge 54, along section line 3-3 in FIG. 2. Circumscribing discharge end 26 of inflator 14 is an elastomeric gasket 60 that has a circumferentially inner surface 62 and a circumferentially outer surface 64. Gasket 60 is disposed filling the space between exterior surface 25 of inflator 14 and inlet portion 22 of airbag 12. Airbag 12 has an interior surface 66, an exterior surface 68, and a thickness T₁₂ measured therebetween. Gasket 60 has a radial thickness T₆₀ measured between inner surface 62 and outer surface 64 thereof that is generally greater than thickness T₁₂ of airbag 12. Inner surface 62 of gasket 60 nondestructively detachably engages exterior surface 25 of inflator 14, while outer surface 64 of gasket 60 is secured to interior surface 66 of airbag 12. Gasket 60 is secured to interior surface 66 of airbag 12 directly, without resort to intermediating structures or materials, such as surface texturing or adhesives. The transverse extent of gasket 60 measured normal to the plane of FIG. 3 is substantially smaller that the longitudinal, circumferential extent of gasket 60 that circumscribes inflator 14.

Gasket 60 is a substantially continuous cured band of a liquid sealant, such as a silicone adhesive. As a result, gasket 60 has material properties that enable inner surface 62 thereof to effect a purchase on exterior surface 25 of inflator 14 that is both mechanically secure and pneumatically sealing. Being secured to interior surface 62 of airbag 12, gasket 60 is carried by airbag 12 during the assembly of discharge end 26 of inflator 14 into inlet portion 22. This reduces the number of individual components that must be processed to render safety module 10 operative in a passenger vehicle.

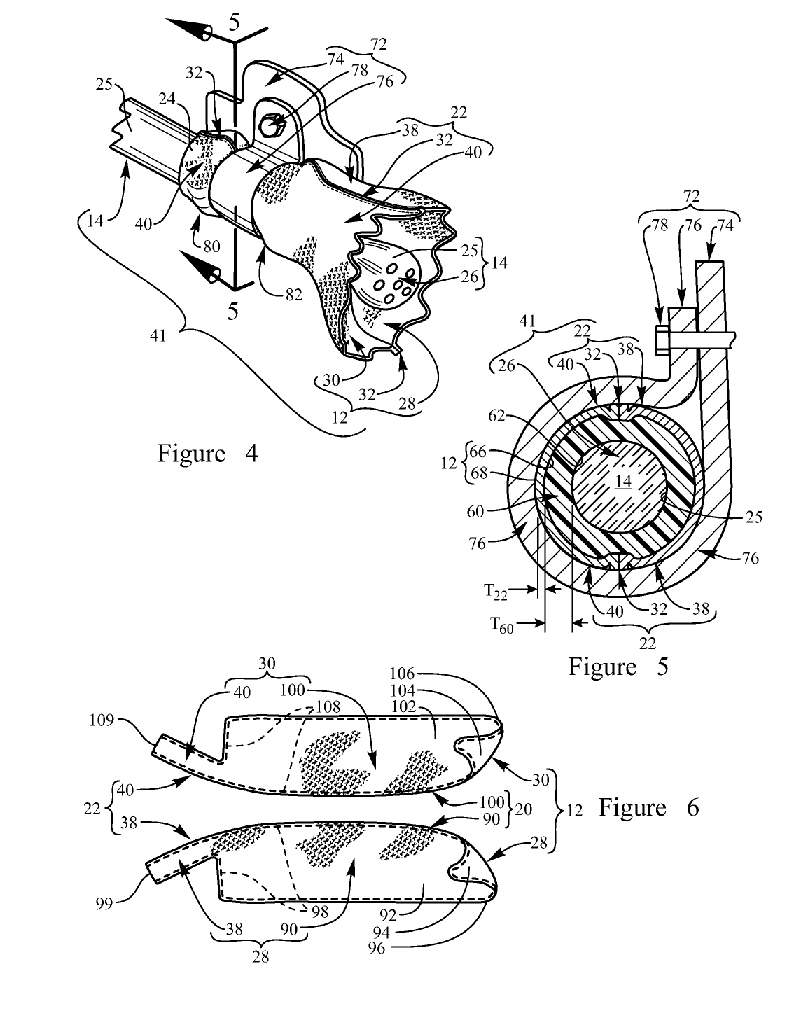

FIG. 4 is a perspective view of a second embodiment of a coupling structure 70 incorporating teachings of the present invention. Airbag 12, inflator 14, and gasket 60 of coupling structure 70 are substantially unchanged from airbag 12, inflator 14, and gasket 60 in FIG. 2, but coupling structure 70 includes an attachment bracket 72 that differs in structure and in effect from attachment bracket 42. Attachment bracket 72 includes a planar base plate 74 and a single curved retention strap 76 that is integrally-formed therewith. Retention strap 76 projects from a lower edge of base plate 74 that is obscured in FIG. 4 by interface subassembly 41. Base plate 74 is secured to a structural element of a vehicle by means not relevant to the present invention, while retention strap 76 wraps circumferentially about interface subassembly 41 at a central location along the length thereof. The free end of retention strap 76 is fastened by bolt 78 to or through base plate 74 as shown. Retention strap 76 thus precludes any lateral displacement of interface subassembly 41. If retention strap 76 exerts a sufficiently powerful radially-inwardly directed grip on interface subassembly 41, retention strap 76 also fixes the longitudinal position of interface subassembly 41 and maintains the integrity of interface subassembly 41 during the activation of airbag 12.

Toward those ends, an inflator-airbag interface, such as coupling structure 70, includes elastomeric gasket 60 (see FIG. 5) that is carried on interior surface 66 (see FIG. 5) of airbag 12 at a location that opposes exterior surface 25 of inflator 14, when discharge end 26 of the inflator 14 is received into inlet portion 22 of airbag 12. In interface subassembly 41, gasket 60 thus becomes sandwiched between exterior surface 25 of inflator 14 and interior surface 66 of airbag 12. While not directly visible in FIG. 4, it is gasket 60 that causes a circumferential first bulge 80 and a circumferential second bulge 82 to appear on the exterior of inlet portion 22 of airbag 12 to either side of retention strap 76.

FIG. 5 is a cross-sectional elevation view of coupling structure 70 taken at retention strap 76, along section line 5-5 in FIG. 4. Gasket 60 is disposed between exterior surface 25 of inflator 14 and interior surface 66 of airbag 12. In contrast to the arrangement of components in coupling structure 16 of FIG. 3, gasket 60 of coupling structure 70 shown in FIG. 5 is compressed radially inwardly by the grip of retention strap 76. Thus in coupling structure 70, gasket 60 has a compressed thickness T₆₀ that is less than radial thickness T₆₀ thereof shown in coupling structure 16 in FIG. 3. Still, compressed thickness T₆₀ of gasket 60 is generally greater than thickness T₂₂ of the wall of airbag 12.

FIG. 6 is a disassembled plan view of the flexible constituent panels of airbag 12, first airbag panel 28 and second airbag panel 30.

First airbag panel 28 includes first neck segment 38, as well as a first inflation segment 90. First inflation segment 90 of first airbag panel 28 eventually serves as a wall of inflation portion 20 of airbag 12. As seen in FIG. 6, first airbag panel 28 has an enclosable side 92, an exposable side 94, and a peripheral edge 96 therebetween. Shown in dashed line extending along the substantial entirety of edge 96 is a first attachment line 98 at which first airbag panel 28 is secured to second airbag panel 30 in producing airbag 12. First attachment line 98 does not, however, follow edge 96 across the tip 99 of first neck segment 38, where open end 24 of airbag 12 is to be created. Once first airbag panel 28 and second airbag panel 30 are secured together, enclosable side 92 of first airbag panel 28 is part of interior surface 66 (FIGS. 3 and 5) of airbag 12, while exposable side 94 of first airbag panel 28 is part of exterior surface 68 (FIGS. 3 and 5) of airbag 12.

Second airbag panel 30 includes second neck segment 40, as well as a second inflation segment 100. Second inflation segment 100 of second airbag panel 30 eventually serves as a wall of inflation portion 20 of airbag 12. As seen in FIG. 6, second airbag panel 30 has an enclosable side 102, an exposable side 104, and a peripheral edge 106 therebetween. Shown in dashed line extending along the substantial entirety of edge 106 is a second attachment line 108 at which second airbag panel 30 is secured to first airbag panel 28 in producing airbag 12. Second attachment line 108 does not, however, follow edge 106 across the tip 109 of second neck segment 40, where open end 24 of airbag 12 is to be created. Once second airbag panel 30 and first airbag panel 28 are secured together, enclosable side 102 of second airbag panel 30 is part of interior surface 66 (FIGS. 3 and 5) of airbag 12, while exposable side 104 of second airbag panel 30 is part of exterior surface 68 (FIGS. 3 and 5) of airbag 12.

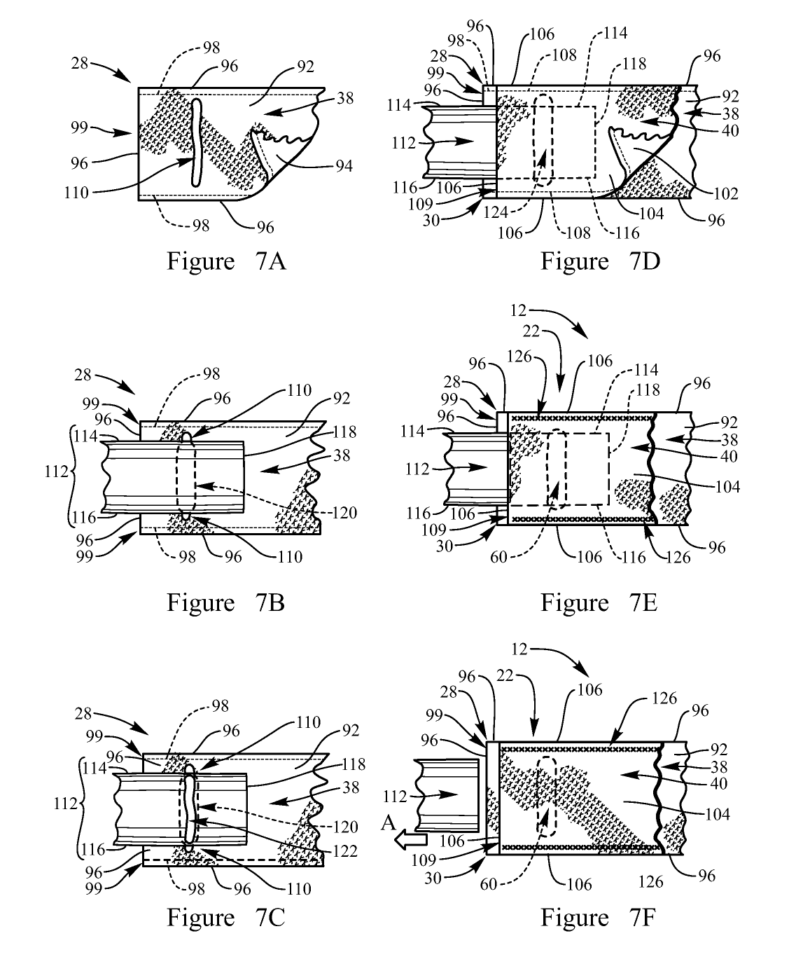

FIGS. 7A-7F are diagrams depicting steps in a method for manufacturing an airbag, such as airbag 12 that, according to teachings of the present invention, carries a gasket, such as gasket 60, by which to effect a mechanically secure and pneumatically sealed attachment of the airbag to the exterior surface of the discharge end of an associated inflator.

FIG. 7A is a plan view of enclosable side 92 of first airbag panel 28 in the vicinity of tip 99 of first neck segment 38 thereof. First attachment line 98 is apparent along edges 96 of first airbag panel 28 to either side of tip 99. Initially, a first bead 110 of a curable liquid adhesive, such as a liquid silicone, is applied to enclosable side 92 of first airbag panel 28. First bead 110 of curable liquid adhesive, generally parallels edge 96 at tip 99 of first neck segment 38, extending substantially from edge 96 on one side of tip 99 to edge 96 on the opposite side therefrom. This corresponds to a circumferential direction about inlet portion 22 of airbag 12, once the manufacture of airbag 12 has been completed.

Next, as shown in FIG. 7B, an elongated mandrel 112 with generally parallel side edges 114, 116, and an end edge 118 is disposed atop and urged against first bead 110 of curable liquid adhesive in longitudinal alignment with first neck segment 38 of first airbag panel 28. Pressure by mandrel 112 against first bead 110 of curable liquid adhesive disburses the liquid adhesive therein laterally into a first broad band 120 of curable liquid adhesive.

The outer surface of mandrel 112 is possessed of such material properties as will permit mandrel 112 to be nondestructively removed from first broad band 120 of curable liquid adhesive, once the adhesive therein has been cured. A covering of untreated nylon fabric on the exterior of mandrel 112 functions satisfactorily relative, for example, to a liquid silicone adhesive. Mandrel 112 is a generally planar structure. The width of mandrel 112 measured transverse the longitudinal extent thereof, between side edges 114, 116, is substantially greater than the thickness of mandrel 112 measured normal to that longitudinal extent. In addition, the perimeter of a transverse cross section of mandrel 112 is usually less than the perimeter of a transverse cross section of the discharge end of the inflator with which airbag 12 is intended to be assembled.

Then, as shown in FIG. 7C, a second bead 122 of a curable liquid adhesive, such as a liquid silicone, is applied to the side of the mandrel 112 that is visible in FIG. 7C, the side of mandrel 112 opposite from first bead 110 and first broad band 114 of curable liquid adhesive. Second bead 122 of curable liquid adhesive is substantially aligned with first bead 110 of curable liquid adhesive on the opposite side of mandrel 112. The ends of second bead 122 of curable liquid adhesive may extend beyond side edges 114, 116, of mandrel 112 to contact the ends of first bead 110 of curable liquid adhesive. For convenience of illustration in FIG. 7C, however, that is not the case: second bead 122 of curable liquid adhesive is shorter than first bead 110 of curable liquid adhesive and shorter than the distance between side edges 114, 116, of mandrel 112.

Next, as shown in FIG. 7D, second neck segment 40 of second airbag panel 30 is disposed over the assembly built up through FIG. 7C with second neck segment 40 generally in alignment with first neck segment 38 of first airbag panel 28. For convenience of illustration in FIG. 7D, however, edge 106 of second neck segment 40 at edge 106 of second airbag panel 30 is shown offset from edge 96 of first neck segment 38 at edge 96 of first airbag panel 28. Enclosable side 102 of second neck segment 40 engages second bead 122 of curable liquid adhesive, mandrel 112, and enclosable side 92 of first airbag panel 28 that are all located directly beneath second neck segment 40.

Compressive processing forces directed normal to the plane of FIG. 7D urge enclosable side 102 of second airbag panel 30 against second bead 122 of a curable liquid adhesive. This disburses the liquid adhesive therein laterally into a second broad band 124 of curable liquid adhesive. Under most manufacturing circumstances, the ends of second broad band 124 of curable liquid adhesive meet and merge with the ends of first broad band 120 of curable liquid adhesive, resulting in a single, continuous broad band of curable liquid adhesive that circumscribes mandrel 112 and engages enclosable side 92 of first airbag panel 28 and enclosable side 102 of second airbag panel 30 in an uninterrupted fashion.

FIG. 7E depicts the result of some final processing steps conducted on the assembly built through FIG. 7D. First, first neck segment 38 of first airbag panel 28 is secured to second neck segment 40 of second airbag panel 30 along each of edges 114, 116, of mandrel 112, thereby forming inlet portion 22 of airbag 12. By way of example, this is accomplished using stitching 126 thorough first neck segment 38 and second neck segment 40 at first attachment line 98 and second attachment line 108, respectively. Second, the liquid adhesive in first broad band 120 and second broad band 124 of liquid adhesive is cured, producing gasket 60 that is attached directly to enclosable side 92 of first airbag panel 28 and enclosable side 102 of second airbag panel 30. Contrastingly, gasket 60 is capable of nondestructive detachment from mandrel 112.

Accordingly, as suggested by arrow A in FIG. 7F, mandrel 112 is withdrawn from the center of gasket 60 and extracted from between first neck segment 38 of first airbag panel 28 and second neck segment 40 of second airbag panel 30. An airbag, such as airbag 12, results that carries an elastomeric gasket, such as gasket 60, on the interior surface of inlet portion 22 thereof.

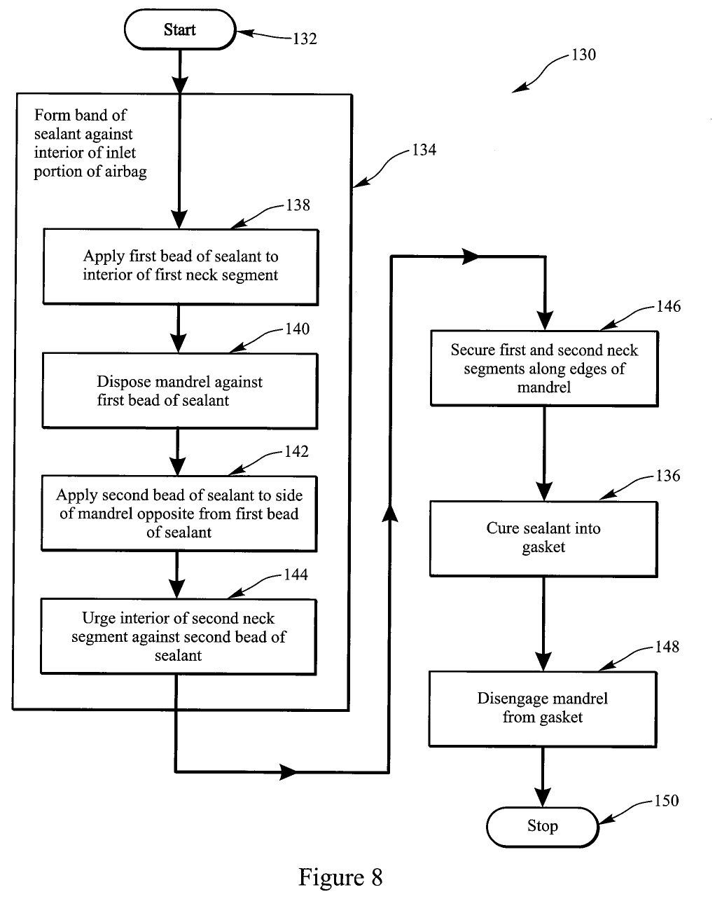

FIG. 8 is a flow chart presenting steps in an embodiment of a method 130 for manufacturing an airbag according to teachings of the present invention.

Commencing at initiation oval 132, method 130 includes the steps set forth in subroutine rectangle 134 of forming a substantially continuous band of curable liquid sealant, such as a curable liquid silicone, against an interior surface of the inlet portion of the airbag at a location opposing and circumscribing the outer surface of the discharge end of an inflator, when the discharge end of the inflator is received into the inlet portion of the airbag. Thereafter method 130 involves the step shown in instruction rectangle 136 of curing the substantially continuous band of liquid sealant into an elastomeric gasket that is carried on the interior surface of the inlet portion of the airbag. Then the mandrel may be disengaged from the gasket 148, leaving the gasket engaging the outer surface of the discharge end of the inflator, when the discharge end of the inflator is received into the inlet portion of the airbag.

In method 130, the inlet portion of the airbag typically includes first and second circumferentially-defined neck segments of respective first and second flexible constituent airbag panels. Employing such first and second neck segments, the forming step of subroutine rectangle 134 begins, as suggested in instruction rectangle 138, with the step of applying a first bead of curable liquid sealant to an interior surface of the first neck segment in substantial alignment with a circumferential direction about the inlet portion of the airbag. Method 130 continues, as suggested in instruction rectangle 140, by disposing an elongated mandrel having substantially parallel edges against the first bead of the sealant in longitudinal alignment with the neck segment. This forms from the first bead of sealant a first band of the sealant. Thereafter, as indicated in instruction rectangle 142, a second bead of the sealant is applied to the side of the mandrel opposite from the first bead of sealant in substantial alignment with the first bead of the sealant. As indicated in instruction rectangle 144, an interior surface of the second neck segment is urged against the second bead of the sealant with the second neck segment in longitudinal alignment with the first neck segment. This forms from the second bead of sealant a second band of the sealant.

Following the forming step of subroutine rectangle 134, but before the curing step of instruction rectangle 136, the first neck segment is secured to the second neck segment along respective of the edges of the mandrel, as suggested in instruction rectangle 146. The first neck segment and the second neck segment thereby form the inlet portion of the airbag under production.

The first band of the sealant and the second band of the sealant together form the substantially continuous band of the sealant called for in subroutine rectangle 134. Accordingly, the curing step of instruction rectangle 136 is conducted with the mandrel between the first neck segment and the second neck segment contacting and circumscribed by the substantially continuous band of the sealant. The step of curing the substantially continuous band of liquid sealant produces an elastomeric gasket that adheres to the first neck segment and to the second neck segment, but that is nondestructively disengageable from the mandrel. Accordingly, as suggested by instruction rectangle 148, the mandrel is disengaged from the center of the gasket and withdrawn from the inlet portion of the airbag under production, and method 130 concludes at termination oval 150.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A coupling structure for effecting interconnection between an inflator and an airbag in a vehicle passenger safety module, the coupling structure comprising a cured band of liquid sealant disposed between an exterior surface of a discharge end of the inflator and an interior surface of an inlet portion of the airbag, when the discharge end of the inflator is received into the inlet portion of the airbag.

2. A coupling structure as recited in claim 1, wherein the cured band is substantially continuous in longitudinal extent.

3. A coupling structure as recited in claim 2, wherein the cured band has a transverse extent, and the transverse extent of the cured band is substantially smaller than the longitudinal extent of the cured band.

4. A coupling structure as recited in claim 2, wherein the cured band circumscribes the discharge end of the inflator, when the discharge end of the inflator is received into the inlet portion of the airbag.

5. A coupling structure as recited in claim 2, wherein the cured band has a thickness, and the thickness of the cured band is greater than the thickness of the wall of the inlet portion of the airbag.

6. A coupling structure as recited in claim 1, wherein the cured band is comprised of cured liquid silicone.

7. A coupling structure as recited in claim 1, wherein the cured band is carried on the interior surface of the inlet portion of the airbag, when the discharge end of the inflator is received into the inlet portion of the airbag.

8. A coupling structure as recited in claim 7, wherein the cured band is secured directly to the interior surface of the inlet portion of the airbag.

9. An airbag for a vehicle passenger safety module, the airbag being deployed by pressurized gas emitted from a discharge end of an inflator of the safety module, and the airbag comprising:
(a) an inflation portion in which to capture the pressurized gas from the inflator;
(b) an inlet portion in pneumatic communication with the inflation portion, the inlet portion being configured to receive the discharge end of the inflator and to be secured to an outer surface thereof, and
(c) an elastomeric gasket carried on an interior surface of the inlet portion at a location opposing the outer surface of the discharge end of the inflator, when the discharge end of the inflator is received into the inlet portion.

10. An airbag as recited in claim 9, wherein the gasket is substantially continuous, and the gasket circumscribes the discharge end of the inflator, when the discharge end of the inflator is received into the inlet portion of the airbag.

11. An airbag as recited in claim 10, wherein the gasket has a longitudinal extent, a transverse extent substantially smaller than the longitudinal extent thereof, and a thickness greater than the thickness of the wall of the inlet portion of the airbag.

12. An airbag as recited in claim 9, wherein the gasket is comprised of cured liquid silicone.

13. A method for manufacturing an airbag for a vehicle passenger safety module, the airbag including an inlet portion configured to receive therein the discharge end of an inflator of the safety module, the method comprising the steps of:
(a) forming a substantially continuous band of curable liquid sealant against an interior surface of the inlet portion of the airbag at a location opposing and circumscribing the outer surface of the discharge end of the inflator, when the discharge end of the inflator is received into the inlet portion of the airbag; and
(b) curing the substantially continuous band of liquid sealant into an elastomeric gasket carried on the interior surface of the inlet portion of the airbag, the gasket engaging the outer surface of the discharge end of the inflator, when the discharge end of the inflator is received into the inlet portion of the airbag.

14. A method as recited in claim 13, wherein the curable liquid sealant comprises a liquid silicone.

15. A method as recited in claim 13, wherein the inlet portion of the airbag comprises first and second circumferentially-defined neck segments of respective first and second flexible constituent airbag panels, and the step of forming comprises the steps of:
(a) applying a first bead of curable liquid sealant to an interior surface of the first neck segment in substantial alignment with a circumferential direction about the inlet portion of the airbag;
(b) disposing an elongated mandrel against the first bead of the sealant in longitudinal alignment with the neck segment, forming from the first bead of sealant a first band of the sealant;
(c) applying a second bead of the sealant to a side of the mandrel opposite from the first bead of sealant in substantial alignment with the first bead of the sealant; and
(d) urging an interior surface of the second neck segment against the second bead of the sealant with the second neck segment in longitudinal alignment with the first neck segment, forming from the second bead of sealant a second band of the sealant.

16. A method as recited in claim 15, further comprising the step of securing the first neck segment to the second neck segment along respective of the edges of the mandrel, the first neck segment and the second neck segment thereby forming the inlet portion of the airbag.

17. A method as recited in claim 15, wherein the first band of the sealant and the second band of the sealant together form the substantially continuous band of the sealant, and the step of curing is conducted with the mandrel between the first neck segment and the second neck segment contacting and circumscribed by the substantially continuous band of the sealant.

18. A method as recited in claim 17, wherein following the step of curing the substantially continuous band of liquid sealant into an elastomeric gasket, the elastomeric gasket adheres to the first neck segment and to the second neck segment, while the mandrel is nondestructively disengageable from the elastomeric gasket.

19. A method as recited in claim 15, wherein the mandrel has a width measured transverse the longitudinal extent thereof and a thickness measured normal to the longitudinal extent thereof, and the width of the mandrel is substantially greater than the thickness thereof.

20. A method as recited in claim 15, wherein the perimeter of a transverse cross section of the discharge end of the inflator is less than the perimeter of a transverse cross section of the mandrel.
